(19) United States
(12) Patent Application Publication
(10) Pub. No.: US 2009/0032133 A1
(43) Pub. Date: Feb. 5, 2009

(54) GAS CHARGING DEVICE, GAS CHARGING METHOD AND METHOD FOR PRODUCING GAS EJECTION DEVICE

(76) Inventor: Ryohei Abe, Tokyo (JP)

Correspondence Address: NOTARO & MICHALOS P.C., 100 DUTCH HILL ROAD, SUITE 110, ORANGEBURG, NY, 10962-2100, US

(21) Appl. No.: 11/912,430

(22) PCT Filed: Apr. 25, 2006
(86) PCT No.: PCT/JP2006/308667

§ 371 Date: Oct. 26, 2007

(30) Foreign Application Priority Data
Apr. 26, 2005 (JP) 2005-128211

(51) Int. Cl. F17C 5/06; F17C 13/06

(52) U.S. Cl. 141/2; 141/8; 141/19; 220/583

(57) ABSTRACT

A gas charging device includes a housing section (61), a gas charging section (62), a lid (64) and an opening member (65). The housing section houses a gas ejection device (1) provided with a gas container (5) and an operating member (9) for opening/closing the gas container. The gas charging section is formed with a supply duct (68) for supplying the gas and a discharge duct (69) for discharging the gas and is faced by one end of the housing section (61). The lid may hermetically seal the gas charging section (62). The operating member may be engaged with the operating member (9) to open the gas container (5). The gas charging section (62), in the housing section (61) of which the gas ejection device (1) is housed, is hermetically sealed by the lid (64), and the gas container (5) of the gas ejection device (1) is opened by the opening member (65). The gas is introduced from the supply duct (68) into the gas charging section (62) to immerse the gas ejection device (1) in the gas to charge the gas into the gas container (5).

### TECHNICAL FIELD

This invention relates to a gas charging device and a gas charging method for charging a gas, such as carbon dioxide (CO₂), into a vessel at a high pressure, and a method for producing a gas ejection device which makes use of the gas charging device and the gas charging method.

The application claims priority rights based on Japanese Patent Application No. 2005-128211 filed in Japan on Apr. 26, 2005. This Patent Application of senior filing data is incorporated by reference into the present application.

### BACKGROUND ART

Up to now, a gas vessel comprised of a small-sized gas container into which compressed gas is charged and sealed hermetically is provided and made available as a dust blower, aerosol or a draft beer server. The gas charged into such small-sized gas container may be inert gases, such as carbon dioxide (CO₂), nitrogen gas (N), helium gas (He) or argon gas (Ar).

For fabricating a small-sized gas container, filled with the inert gas, a small-sized gas container is placed in a hermetically sealed chamber, a compressed gas, as an object of charging, is charged into the hermetically sealed chamber and thereafter a sealing plate is welded to a charging port.

However, in this method for charging the compressed gas, it is necessary to provide a welding unit for hermetically sealing a charging port of the small-sized gas container in the hermetically sealed chamber with the sealing plate, thus complicating and increasing the size of the gas charging device. In addition, the process for fabricating the gas ejection device employing the small-sized gas container becomes complex and expensive.

Moreover, since the small-sized gas container is hermetically sealed by welding the sealing plate, the small-sized gas container may no longer be filled with the compressed gas or hermetically sealed if once the sealing plate is opened. Hence the gas container is necessarily thrown away after use.
Patent Publication 1 JP 2003-212212 A
Patent Publication 2 JP 2004-197783A

### DISCLOSURE OF THE INVENTION

### Problems to be Solved by the Invention

It is therefore an object of the present invention to provide a gas charging device, a gas charging method and a method for producing a gas ejection device, in which a compressed gas can be charged into a small-sized gas container with ease, and the small-sized gas container so filled with the gas may then be sealed hermetically without using a welding unit. The gas ejection device is to be produced speedily and inexpensively. Moreover, the compressed gas is to be re-chargeable if once the sealing plate is opened, or unstopped.

### Problems to be Solved by the Invention

For accomplishing the above object, a gas charging device according to the present invention provides a gas charging device comprising a housing section for housing a gas container and an operating member for opening/closing the gas container, a gas charging section formed with a supply duct for a gas and faced by an end of the housing section, a lid for hermetically sealing the gas charging section and an opening member engaged with the operating member for opening the gas container. The gas charging section, having the gas ejection device housed in the housing section, is hermetically sealed by the lid, and the gas container of the gas ejection device is opened by the opening member. The gas is introduced via the supply duct into the gas charging section to immerse the gas ejection device in the gas to charge the gas into the gas container.

A method for producing a gas ejection device according to the present invention comprises housing a gas ejection device in a housing section facing a gas charging section provided with a duct for supplying a gas and a duct for discharging the gas, closing a lid for hermetically sealing the gas charging section, engaging an operating member, configured to open or close a gas container housed in the gas ejection device, with an opening member, for opening the gas container, introducing the gas via the duct into the gas charging section for immersing the gas ejection device in the gas for charging the gas in the gas container, disengaging the opening member from the operating member after halting the supply of the gas to close the gas container and taking out the gas ejection device from the housing section.

A gas charging method according to the present invention comprises housing a gas ejection device in a housing section facing a gas charging section including a supply duct for supplying a gas and a discharging duct for discharging the gas. The gas ejection device includes a container having an opening part sealed by a sealing plate, and filled with a compressed gas, a needle-like member pricked into a pierced opening formed in the sealing plate to close the sealing plate, a holder carrying the needle-like member at one end thereof facing a sealing plate of the container and movable into contact with and away from the sealing plate, a biasing member for biasing the holder towards the sealing plate of the container, an operating lever abutted by the holder at one side thereof referenced to a fulcrum provided at a portion along the length of the operating lever, to cause movement of the holder in a direction away from the sealing plate to open the gas container, a thrusting member engaging with and thrust by an opposite side end of the operating lever referenced to the fulcrum to cause rotation of the operating lever in a direction of moving the holder away from the sealing plate to uplift the needle-like member out of the pierced opening to open the gas container, and a housing for housing the container and the holder and including a gas duct for outwardly guiding the compressed gas ejected via the pierced opening in the sealing plate. The gas charging method also comprises hermetically sealing the gas charging section, pressing down the operating member by an opening member to open the gas container, and introducing the gas from the supply duct into the gas charging section via the supply duct for immersing the gas ejection device in the gas for charging the gas in the gas container.

### Effect of the Invention

With the gas charging device, gas charging method and the method for producing the gas ejection device, described above, the gas container of the gas ejection device may be opened/closed by operating means. Gas charging and sealing the gas container may be achieved by a simplified step of opening the gas container by operating means of the opening member and immersing the gas ejection device in the gas. The gas may be charged extremely readily without the complex step of welding a sealing plate under a gas-tight state of the charged gas. On the other hand, there is no necessity of providing a gas-tight chamber provided with a welding mechanism, and hence there is no fear that the gas charging device becomes complex or bulky.

Moreover, the gas ejection device allows for repeated opening/closure of the gas container, so that, even if the charged gas has been used up, any desired number of gas ejection devices may repeatedly be produced on re-charging the gas.

### BRIEF DESCRIPTION OF THE DRAWINGS

FIG. 1 is an exploded perspective view showing a gas ejection device produced according to the present invention.

FIG. 2 is an exploded perspective view of the gas ejection device.

FIG. 3 is a plan view showing the inside of the housing of the gas ejection device.

FIG. 4 is a perspective view showing an inner structure of the gas ejection device, with a portion thereof being broken away.

FIG. 5 is a perspective view showing an inner structure of the gas ejection device, during its gas ejecting operation, with a portion thereof being broken away.

FIG. 6 is a perspective view of an as-assembled structure of the gas ejection device, with a portion thereof being broken away.

FIG. 7 is a perspective view of an as-assembled structure of the gas ejection device.

FIG. 8 is an exploded perspective view of a gas charging device according to the present invention.

FIG. 9 is a plan view showing the inside of the gas charging device connected to the gas container.

FIG. 10 is a cross-sectional view showing the gas charging device the gas ejection device can be housed in or taken out from.

FIG. 11 is a gas charging device for charging the gas into the gas ejection device.

FIG. 12 is a cross-sectional view showing the gas charging device the residual gas is taken out from.

### BEST MODE FOR CARRYING OUT THE INVENTION

The gas charging device, gas charging method and the gas ejection device according to the present invention will now be described in detail with reference to the drawings. Initially, a gas ejection device 1, used in the present invention, will be described.

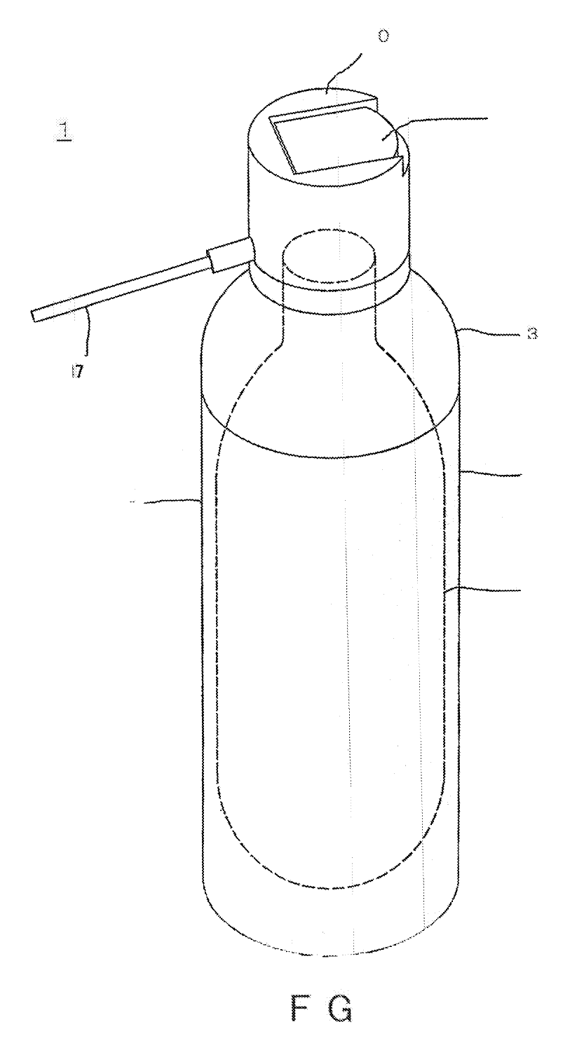

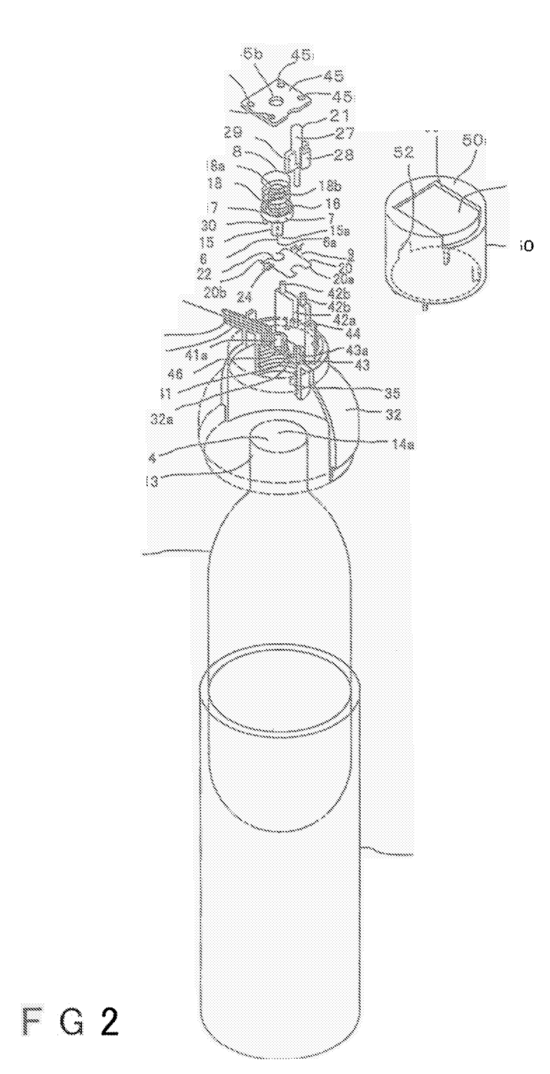

This gas ejection device 1 is used for fabrication and repair of precision instruments or as a dust blower for removing dust and dirt in handling a negative of a photo or a semiconductor device, for instance. Referring to FIGS. 1 and 2, the gas ejection device 1 includes a carbonic gas cartridge container 5, a holder 7, a torsion coil spring 8, an operating member 9, and a housing 10. The carbonic gas cartridge container 5 has been filled with a carbonic gas as a compressed gas. The holder holds a needle-like member 6 configured to open or close the carbonic gas cartridge container 5. The torsion coil spring biases the holder 7 towards an opening side of the carbonic gas cartridge container 5. The operating member 9 is used to move the holder 7 away from the opening of the carbonic gas cartridge container 5 to eject the carbonic gas, or to charge the gas. The housing 10 holds the carbonic gas cartridge container 5 and the holder 7, and includes a gas duct 11 via which the carbonic gas ejected from the carbonic gas cartridge container 5 may be led to outside or the carbonic gas may be introduced into the inside of the carbonic gas cartridge container 5.

The carbonic gas cartridge container 5 is a substantially cylindrically-shaped metal enclosure within which is charged a liquefied carbonic gas. An opening 13 is formed on one end of the metal enclosure of the carbonic gas cartridge container 5. This opening 13 is covered by a sealing plate 14 to prevent ejection of the carbonic gas contained in a metal enclosure. A pierced opening 14a is formed in the sealing plate 14 in the opening 13 by the needle-like member 6 held by the holder 7. The opening 13 is closed by the needle-like member 6 pricked into the pierced opening 14a.

With the carbonic gas cartridge container 5, the pierced opening 14a in the sealing plate 14 is opened on uplifting the needle-like member 6 pricked through the sealing plate 14 to eject the carbonic gas charged in the inside of the container, or to charge the carbonic gas into the inside of the housing. Also, with the carbonic gas cartridge container 5, the opening 13 is closed on pricking the needle-like member 6 through the pierced opening 14a to prevent ejection of the carbonic gas.

The holder 7, holding the needle-like member 6 and configured to open or close the carbonic gas cartridge container 5, has a substantially convexed cross-sectional profile, and includes a protrusion 15, a flange part 17 and an enclosing portion 18 for the torsion coil spring 8. The protrusion 15 is passed through by and holds the needle-like member 6, pricked through the sealing plate 14 of the carbonic gas cartridge container 5. The flange part 17 is formed with a retention groove 16 for retaining the torsion coil spring 8 configured to bias the holder 7 towards the carbonic gas cartridge container 5.

The protrusion 15, passed through by and holding the needle-like member 6, is slidably carried by a holder guide wall section 41 formed on a housing 10 as later described. The holder guide wall section 41 guides the needle-like member 6 moved in a direction towards or away from the carbonic gas cartridge container 5. The holder 7 is also abutted by the operating member 9 as later described to enable the protrusion 15 to be moved in a direction away from the carbonic gas cartridge container 5 against the bias of the torsion coil spring 8.

The needle-like member 6, closing the sealing plate 14 of the carbonic gas cartridge container 5, has a needle end part 6a protruded from a bottom surface 15a of the protrusion 15 and pricked into the sealing plate 14 of the carbonic gas cartridge container 5. Thus, the needle-like member 6 is able to pierce through the sealing plate 14 to form the pierced opening 14a to release or charge the carbonic gas. The needle-like member 6 is also able to close the pierced opening 14a to prevent outflow of the charged carbonic gas from the carbonic gas cartridge container 5.

The flange part 17, formed at the end of the holder 7 facing the carbonic gas cartridge container 5, is engaged by the torsion coil spring 8 operating for biasing the holder 7. The holder 7 is housed in an upper enclosure 32 of the housing 10, as later described, with the torsion coil spring 8 engaging with the holder 7, whereby the torsion coil spring has its one end abutted against a top plate 45 of the housing 10, while having its other end retained by the retention groove 16 of the flange part 17. Thus, the torsion coil spring 8 biases the holder 7 towards the sealing plate 14 of the carbonic gas cartridge container 5.

The flange part 17 is also formed with a downturned protuberance 30 abutted by a lever part 20 of the operating member 9. The protuberance 30, thus abutted by the lever part 20, transmits the biasing force of the torsion coil spring 8 to the lever part 20, while transmitting the biasing force of the lever part 20, rotationally operated by the operating member 9, to the holder 7.

The enclosing portion 18, protuberantly formed on the opposite side of the protrusion, with the flange part 17 in-between, is passed through by the torsion coil spring 8, whereby the torsion coil spring 8 may be retained and held by the holder 7. Since the distal end 18a of the enclosing portion 18 is of a smaller diameter, there is formed a flange part 18b introduced into and retained by the top plate 45 as later described.

When the holder 7, described above, is accommodated in the housing 10, the sealing plate 14 of the carbonic gas cartridge container 5 faces the bottom surface 15a of the protrusion 15 formed with the needle-like member 6. Since the holder 7 is biased by the torsion coil spring 8 towards the carbonic gas cartridge container 5, the needle-like member 6 pierces through the sealing plate 14, with the needle end part 6a pricking through the pierced opening 14a to close the carbonic gas cartridge container 5.

If the holder 7 is moved by the operating member 9 in a direction away from the carbonic gas cartridge container 5, against the force of the torsion coil spring 8, the needle end part 6a of the needle-like member 6 is uplifted away from the sealing plate 14, thus ejecting or charging the carbonic gas. The carbonic gas, thus ejected, flows through a gas duct 11 of the housing 10 so as to be ejected outwards. When the biasing force to the operating member 9 is removed, the holder 7 is biased towards the carbonic gas cartridge container 5, under the biasing force of the torsion coil spring 8. The needle end part 6a of the needle-like member 6 is pricked through the pierced opening 14a of the sealing plate 14 of the carbonic gas cartridge container 5 to halt the ejection of the carbonic gas.

Meanwhile, the torsion coil spring 8 that acts on the holder in a direction towards the carbonic gas cartridge container 5 biases the holder 7 with a pressure greater than the pressure with which the carbonic gas charged into the carbonic gas cartridge container acts on the needle end part 6a of the needle-like member 6 introduced via the pierced opening 14a in the sealing plate 14 into the inside of the carbonic gas cartridge container. That is, the needle-like member 6, retained by the holder 7, is not extruded out of the pierced opening 14a of the sealing plate 14, under the gas pressure in the container, even if the needle-like member is pricked via the pierced opening 14a in the sealing plate 14 into the inside of the carbonic gas cartridge container 5. Hence, with the gas ejection device 1, the carbonic gas charged into the carbonic gas cartridge container 5 is prevented from leaking before the operating member 9 acts on the holder 7.

The operating member 9, ejecting the carbonic gas from or charging the gas into the carbonic gas cartridge container 5 by acting on the holder 7, includes a lever part 20 and a thrusting shank 21. The lever part 20 is engaged with the protrusion 15 of the holder 7 and rotationally carried by the housing 10. The thrusting shank 21 thrusts one end 20a of the lever part 20.

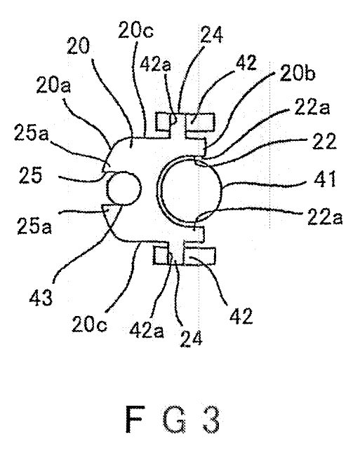

Referring to FIGS. 2 and 3, the lever part 20 is a plate-like member, an end 20b of which is cut out to substantially an arcuate shape to form a first cut-out 22 in keeping with the shape of the holder guide wall section 41 of the housing 10. This first cut-out 22 includes facing side edge parts 22a, 22a located below the flange part 17 of the holder 7. When the end 20b of the lever part 20 is rotated upwards, the facing side edge parts are abutted on a protuberance 30 of the flange part 17 to thrust the holder 7 upwards. Outer lateral sides 20c, 20c of the lever part 20 are formed with rotational lugs 24 carried by a slit 42a of a support wall section 42 provided on the housing 10. The rotational lug 24 is columnar-shaped and is carried by the slit 42a of the support wall section 42 which will be described subsequently. The other end 20a of the lever part 20 is formed with a second cut-out 25 engaged by one end of the thrusting shank 21. The second cut-out 25 is formed by substantially arcuately cutting out the other end 20a of the lever part 20 in keeping with the profile of a thrusting shank guide wall section 43. The second cut-out 25 is passed through by the thrusting shank 21 and has its facing lateral edge parts 25a, 25a thrust by a thrusting segment 29 protuberantly formed on the thrusting shank 21. When the thrusting shank 21 is thrust, the lever part 20 is thrust by the thrusting segment 29 so that its end 20a is rotated downwards.

The thrusting shank 21, engaged by the second cut-out 25 of the lever part 20, includes a shank part 27, a support segment 28 and a thrusting segment 29. When the carbonic gas is ejected or charged, the shank part 27 is thrust via an ejection button 51 of a cap 50 mounted on the upper enclosure 32 of the housing 10. The support segment 28 is carried for movement vertically within the housing 10, and the thrusting segment 29 is abutted by the end 20a of the lever part 20 to thrust the lever part 20 upwards. The shank part 27 has an upper extreme end abutted against the ejection button 51 of the cap 50, while having a lower extreme end introduced into the thrusting shank guide wall section 43 to guide longitudinal movement of the thrusting shank 21. The support segment 28 has a substantially tee shaped cross-sectional profile and is protuberantly formed for extending from a longitudinally mid part of the thrusting shank 21 along the longitudinal direction. The support segment 28 is movably engaged with a guide rail 44 mounted upright on the housing 10 for extending along the longitudinal direction of the thrusting shank 21. The thrusting shank 21 is guided in its movement by this guide rail 44 as well. The thrusting segment 29 is abutted against the lateral edge parts 25a, 25a of the lever member 20 to cause downward rotation of the end 20a of the lever member 20.

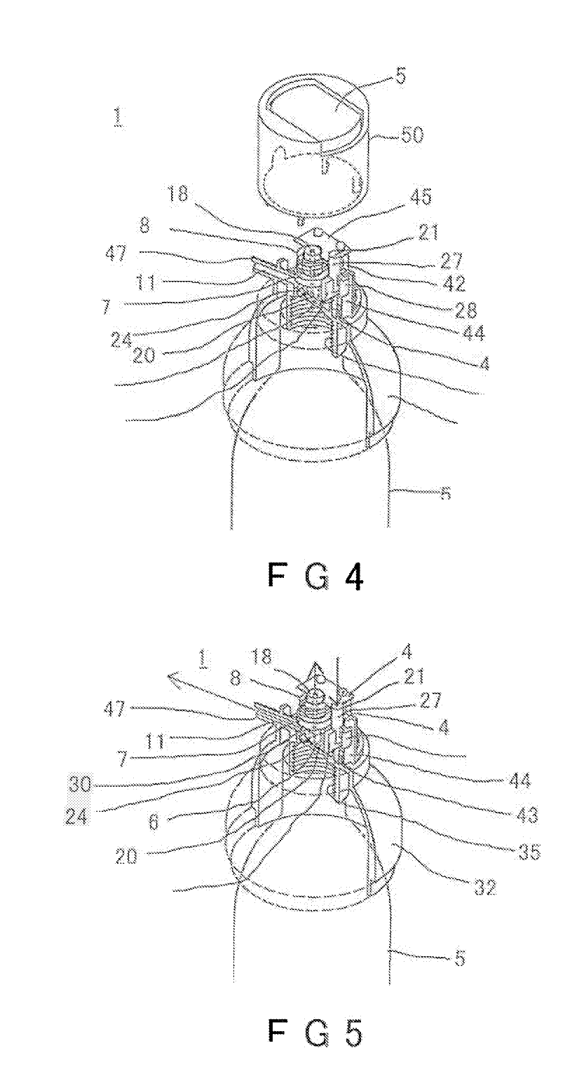

The end 20b of the operating member 9, on the opposite side of the rotational lugs 24, is thrust downwards by the protuberance 30 formed on the flange part 17 of the holder 7 biased at all times by the torsion coil spring 8 towards the carbonic gas cartridge container 5. Thus, the end 20b of the lever member of the operating member 9 is turned downwards, with the rotational lugs 24, 24 as fulcrum, with the other end 20a thereof being turned upwards, as shown in FIG. 4. Hence, the thrusting shank 21 is thrust by the lateral edge parts 25a, 25a provided on the end 20a of the lever part 20 so that the thrusting shank is uplifted upwards at all times.

When the ejection button 51 of the cap 50 is thrust downwards on ejection or charging of the carbonic gas, the shank part 27 of the thrusting shank 21 is thrust downwards by the ejection button 51. Hence, the lower extreme end of the shank part 27 is introduced into a recessed part 43a of the thrusting shank guide wall section 43, while the support segment 28 is moved downwards, as it is guided by the guide rail 44, at the same time as the thrusting segment 29 thrusts the lateral edge parts 25a, 25a of the lever part 20 downwards. This causes the end 20a of the lever part 20 to be rotated downwards, while its end 20b is rotated upwards, with the rotational lugs 24 as fulcrum. Thus, the paired side edge parts 22a, 22a, formed at the end 20b of the lever part 20, are abutted by the downturned protuberance 30 of the flange part 17, and hence the holder 7 is uplifted against the bias of the torsion coil spring 8 away from the sealing plate 14 of the carbonic gas cartridge container 5. Since this uplifts the needle end part 6a of the needle-like member 6, carried by the holder 7, away from the sealing plate 14 of the carbonic gas cartridge container 5, the carbonic gas may be ejected or charged in desired manner.

The housing 10 for the carbonic gas cartridge container 5 and the holder 7, is a substantially tubular member of a thermoplastic resin, such as ABS resin, made up of a lower enclosure 31 and an upper enclosure 32. The cartridge container 5 is housed within the lower enclosure 31, whereas the holder 7 is housed in the upper enclosure 32. The housing 10 is of a size that can be held with one hand of the user. A carbonic gas duct 11 is formed within the upper enclosure 32 of the housing 10.

The lower enclosure 31 is approximately of the same height and diameter as the carbonic gas cartridge container 5 and houses the carbonic gas cartridge container 5 without play.

The upper enclosure 32, housing the holder 7 therein, is formed as one with or removably mounted on the lower enclosure 31. The upper enclosure 32 includes the holder guide wall section 41, paired support wall sections 42, 42, thrusting shank guide wall section 43, guide rails 44, 44, and the top plate 45. The holder guide wall section 41 guides the movement of the protrusion 15 of the holder 7 by its lower surface section 32a. The support wall sections 42, 42 carry the rotational lugs 24, 24 of the lever part 20, and the thrusting shank guide wall section 43 guides the movement of the thrusting shank 21. The guide rails are engaged by the support segment 28 of the thrusting shank 21. The top plate 45 is mounted at the extreme upper ends of the support wall sections 42, 42 and is engaged by one end of the torsion coil spring 8. The upper enclosure 32 is covered by mounting the cap 50 on the lower surface section 32a.

The holder guide wall section 41 is protuberantly formed on the lower surface section 32a of the upper enclosure 32 to slidably support the protrusion 15 of the holder 7. In a recessed part 41 a of the holder guide wall section 41, passed through by the protrusion 15 of the holder 7, is formed a through-hole 46 passed through by the needle-like member 6 carried by the holder 7. This through-hole 46 is formed by the needle-like member 6 piercing through the lower surface section 32a at the same time as the needle-like member 6 pierces through the sealing plate 14 of the carbonic gas cartridge container 5. Hence, the through-hole 46 is of the same diameter as the needle-like member 6, and the lower surface section 32a is formed of lubricious and resilient material, such as polyethylene, in order to guide the movement of the needle-like member 6. Moreover, when the needle-like member 6 is pulled out of the pierced opening 14a of the sealing plate 14, no gap is formed between the through-hole 46 and the needle-like member 6, such as to prevent the carbonic gas from flowing into the upper enclosure 32.

The support wall sections 42, 42 are protuberantly formed on the upper surface of the lower surface section 32a of the upper enclosure 32 and are formed with slits 42a for rotationally carrying the rotational lugs 24, 24 of the lever part 20. The slits 42a are opened in the upper lateral sides of the support wall sections 42, 42. It is via these opened ends that the rotational lugs 24, 24 of the lever part 20 are introduced. A plural number of engagement projections 42b, engaging with the top plate 45, are protuberantly formed on the upper lateral surface parts of the support wall sections 42, 42.

The thrusting shank guide wall section 43 is formed in an upper side of the lower surface section 32a of the upper enclosure 32, and slidably supports the shank part 27 of the thrusting shank 21 to guide the movement of the thrusting shank 21. The thrusting shank guide wall section 43 is formed with a substantially circular-shaped recessed part 43a of a diameter corresponding to the diameter of the shank part 27 of the thrusting shank 21. The shank part 27 is slid within this recessed part 43a to guide the movement of the thrusting shank 21.

The guide rails 44, 44 are protuberantly formed on the upper surface of the lower surface section 32a of the upper enclosure 32 to a substantially L-shaped cross-section. The guide rails 44, 44 are arranged in a U-shape, with the sides of the letter L facing each other to define a slit extending in the longitudinal direction, with the open side of the letter U facing in the opposite direction with respect to the thrusting shank 21. The thrusting shank 21 is slidably carried by the support segment 28 of the substantially tee shaped cross-section engaging in the slit part.

The top plate 45 is formed with a through-hole 45a passed through by the engagement projections 42b protuberantly formed on the upper lateral sides of the support wall sections 42, 42. The top plate 45 is carried by the support wall sections 42, 42 by the engagement projections 42b passed through the through-hole 45a. This top plate 45 is abutted by an end of the torsion coil spring 8 the other end of which is retained by a retention groove 16 formed in the flange part 17 of the holder 7. Thus, the holder 7 is biased by the torsion coil spring 8 towards the carbonic gas cartridge container 5. The top plate 45 is formed with an opening 45b passed through by a foremost part 18a of the enclosing portion 18 for the holder 7 and which retains a flange part 18b of the enclosing portion 18.

The inner surface of the upper enclosure 32 is formed with a retention hole 35 used for screwing the vicinity of the opening 13 of the carbonic gas cartridge container 5 to the lower surface of the lower surface section 32a. The retention hole 35 is formed with a screw thread in which meshes the opening 13 of the carbonic gas cartridge container 5. Thus, when housed in the housing 10, the carbonic gas cartridge container 5 has the opening 13 carried by the retention hole 35 and hence may be housed in position without play. With the carbonic gas cartridge container 5, there is formed at this time a clearance between the sealing plate 14 and the lower surface section 32a of the upper enclosure 32 for guiding the carbonic gas to the carbonic gas duct 11.

The upper enclosure 32 is formed with the carbonic gas duct 11 for guiding the carbonic gas ejected from the carbonic gas cartridge container 5 to outside and for guiding the carbonic gas introduced by a gas charging device into the carbonic gas cartridge container 5. The gas charging device will be described later in detail. The gas duct 11 is provided in a conduit 47 extended outwards from the lower surface section 32a of the upper enclosure 32. One end of the conduit 47 faces the inside of the retention hole 35, while facing the sealing plate 14 of the carbonic gas cartridge container 5, threaded to the retention hole 35, with a preset clearance in-between. Since the opposite end of the conduit 47 faces outwards, the gas duct 11 is flown through by the carbonic gas ejected via the pierced opening 14a in the sealing plate 14. The carbonic gas introduced by the gas charging device is also caused to flow towards the pierced opening 14a in the sealing plate 14. Meanwhile, the conduit 47 is protruded outwards from the housing 10, as shown in FIG. 1. Moreover, an ejection nozzle 37 is removably attached to the conduit 47, so that, by mounting the ejection nozzle 37 in position, the carbonic gas may vigorously be ejected to a precisely defined target area.

The cap 50, mounted on the upper enclosure 32, is a cylindrically-shaped hollow casing with an open end. With the cap 50 mounted on the upper enclosure 32, the holder 7 or the operating member 9, for example, mounted on the lower surface section 32a, may be housed in position, while the outer extreme end of the conduit 47, having the gas duct 11 therein, may face outwards.

The ejection button 51, for acting on the thrusting shank 21, is provided in a closed upper surface section 50a of the cap 50. A recessed part 52, in which the foremost part of the conduit 47 is introduced, is formed in an outer peripheral part of the cap. In the upper surface section 50a of the cap 50 is formed an opening 53 in which to mount the ejection button 51. The upper surface section 50a of the cap is cut out in a rectangular profile to form the opening 53 facing the outer rim of the upper surface section. The ejection button 51, provided in the opening 53, is rotationally connected to the cap 50 via a hinge, not shown, provided on the closed end of the opening 53. The ejection button 51 is abutted by one end of the shank part 27 of the thrusting shank 21 and may be acted on by the user to move the thrusting shank 21 downwards. The ejection button 51 is uplifted by the thrusting shank 21 biased by the torsion coil spring 8 via the lever part 20.

The recessed part 52 is formed with its lower end facing the open end of the cap 50 by substantially arcuately cutting out a part of the outer rim of the cap 50. The foremost part of the conduit 47 of the gas duct 11 is engaged with the open end of the recessed part 52 by fitting the cap 50 on the housing 10 from above the upper enclosure 32.

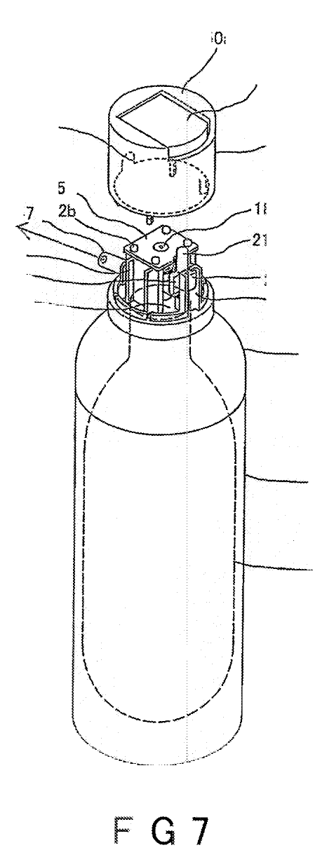

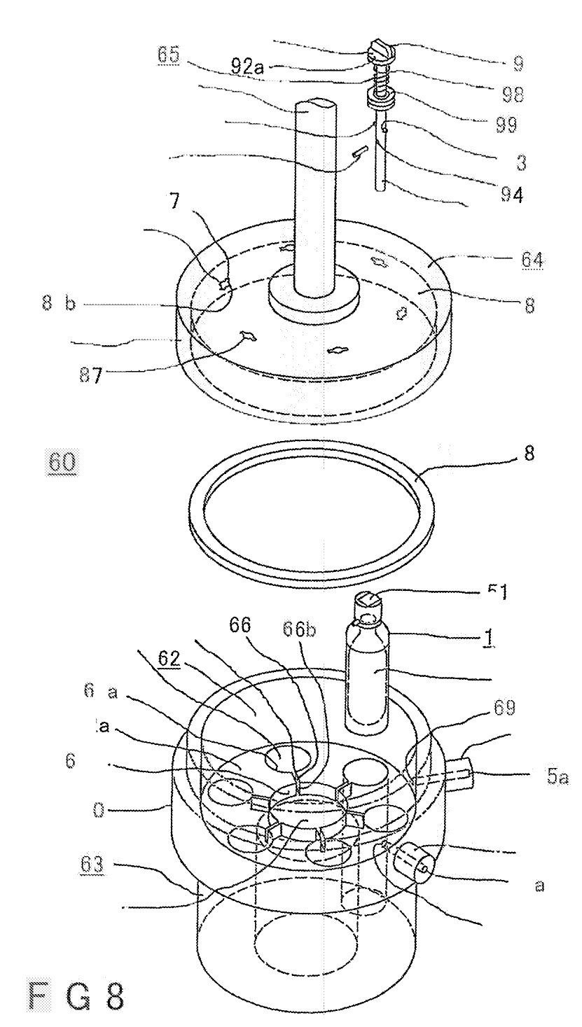

Referring to FIGS. 6 and 7, the gas ejection device 1 has been assembled when the carbonic gas cartridge container 5 is mounted on the upper enclosure 32, the lower enclosure 31 is mounted in position, the holder 7 and the operating member 9 are assembled on the lower surface section 32a, having mounted thereon the holder guide wall section 41, paired support wall sections 42, 42, thrusting shank guide wall section 43, guide rails 44, 44, top plate 45 and the conduit 47, and the cap 50 is thereafter mounted for overlying the upper enclosure 32.

Meanwhile, the opening/closing state of the carbonic gas cartridge container 5 may be checked in a state in which the holder 7 and the operating member 9 are assembled in position. That is, with the gas ejection device 1, the operation may be checked, before mounting the cap 50, when the holder 7 and the torsion coil spring 8 have been retained by the top plate 45 fitted to the support wall sections 42, 42. Thus, unlike the case of checking the opening/closing operation of the carbonic gas cartridge container after retaining the holder and the torsion coil spring by the cap and applying the cap, it is possible to dispense with the labor of dismounting the cap 50 each time the inner structure is checked for possible malfunctions.

The operation of the above-described gas ejection device 1 during its actual use will now be described. In using the gas ejection device 1, the ejection nozzle 37 is connected to the conduit 47, provided in the upper enclosure 32 of the housing 10, for connecting the gas duct 11 to the ejection nozzle 37, as shown in FIG. 1.

With the carbonic gas cartridge container 5, housed in the lower enclosure 31 of the housing 10, the holder 7 is biased downwards by the torsion coil spring 8, as shown in FIG. 4. Hence, the needle end part 6a of the needle-like member 6, carried by the holder 7, is pricked through the sealing plate 14 to form the pierced opening 14a at the outset. The pierced opening 14a is closed by the needle end part 6a of the needle-like member 6 to prevent ejection of the carbonic gas.

The lever part 20 of the operating member 9 at this time is acted on by the protuberance 30 of the holder 7 which is biased at all times towards the carbonic gas cartridge container 5 by the torsion coil spring 8. Hence, the end 20b of the lever part 20 is rotated downwards, about the rotational lugs 24 as the center of rotation, with its other end 20a being rotated upwards. Thus, the thrusting shank 21, the thrusting segment 29 of which is engaged with the lateral edge part 25a of the lever part 20, has its shank part 27 uplifted at all times.

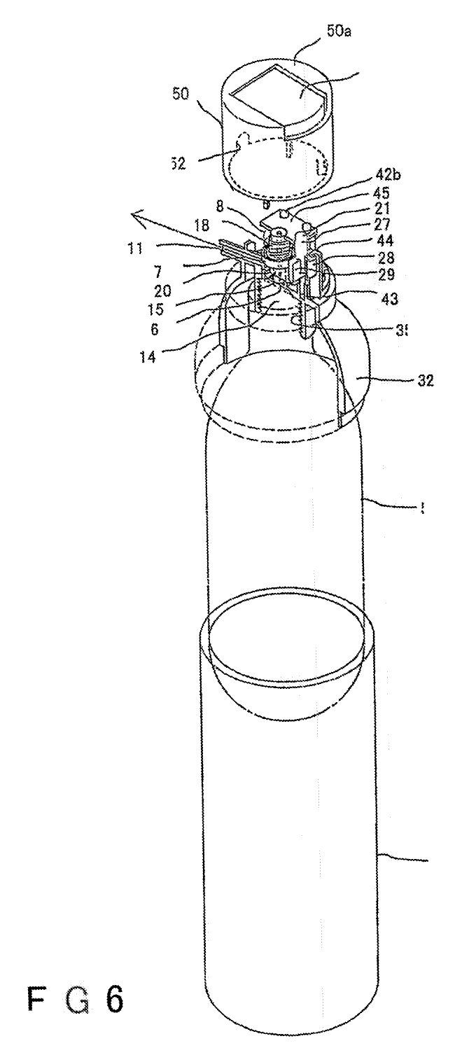

The user then grips the housing 10 of the gas ejection device 1, as an ejection port 37a at the distal end of the ejection nozzle 37 is directed to a target for ejection. The user then acts on the ejection button 51 of the cap 50. The thrusting shank 21 of the operating member 9 is then moved downwards, as shown in FIG. 5. The end 20a of the lever part 20, engaged with the thrusting shank 21, is rotated downwards, with the rotational lugs 24 as a fulcrum. The opposite end 20a of the lever part 20 is rotated upwards. Since the side edge parts 22a, 22a, formed at the end 20b of the lever part 20, are abutted by the protuberance 30 of the flange part 17, the holder 7 is uplifted, against the bias of the torsion coil spring 8, away from the sealing plate 14 of the carbonic gas cartridge container 5. This uplifts the needle end part 6a of the needle-like member 6, carried by the holder 7, away from the pierced opening 14a of the sealing plate 14 of the carbonic gas cartridge container 5. Hence, the carbonic gas cartridge container 5 is opened to eject the carbonic gas compressed in the container.

The so ejected carbonic gas flows via gas duct 11 provided in the upper enclosure 32 of the housing 10 to the ejection nozzle 37 mounted on the conduit 47 and is ejected via the ejection port 37a of the ejection nozzle 37.

When the user releases the pressure applied to the ejection button 51 of the cap 50 to remove the pressure applied to the thrusting shank 21 of the operating member 9, the holder 7 is biased towards the carbonic gas cartridge container 5 under the bias of the torsion coil spring 8, as shown in FIG. 4. Thus, the needle-like member 6, carried by the holder 7, is pricked through the pierced opening 14a of the sealing plate 14 of the carbonic gas cartridge container 5 to close the carbonic gas cartridge container 5. This halts ejection of the carbonic gas from the ejection nozzle 37.

On the other hand, the lever part 20 has the end 20b thrust by the protuberance 30 of the holder 7, biased towards the carbonic gas cartridge container 5. Hence, the end 20a of the lever part is rotated upwards, about the rotational lugs 24 as fulcrum. Thus, the shank part 27 of the thrusting shank 21, engaged with the end 20a of the lever part 20, is moved upwards, while the ejection button 51, abutted by the shank part 27, is uplifted towards the upper surface section 50a.

Thus, in the state of the gas ejection device 1, in which the carbonic gas is charged in the inside of the carbonic gas cartridge container 5, formed by a metallic enclosure, and the ejection of the carbonic gas is halted, the holder 7 is biased towards the carbonic gas cartridge container 5 to close the sealing plate 14 of the carbonic gas cartridge container 5 by the needle end part 6a of the needle-like member 6 to prohibit ejection of the carbonic gas. That is, with the gas ejection device 1, carbonic gas ejection may reliably be controlled by a simplified operation of introducing or extracting the needle-like member 6 to or from the sealing plate 14.

A gas charging device 60 for charging the carbonic gas into the inside of the gas ejection device 1, in case the carbonic gas once charged into the gas ejection device 1 has been used up, or the gas is charged into the gas ejection device 1 which is being produced, will now be described. The gas ejection device 1 is housed within this gas charging device 60, and the carbonic gas is charged from a carbonic gas container connected to the gas charging device 60 via gas supply duct to charge the carbonic gas in the carbonic gas cartridge container 5 housed within the gas charging device.

Referring to FIG. 8, the gas charging device 60 includes a housing section 61 for housing the gas ejection device 1 therein, a gas charging section 62, a main body unit 63, a lid 64 and an opening member 65. The gas charging section 62 is faced by an upper extreme end of the housing section 61 and the carbonic gas is charged in the gas charging section. The main body unit 63 is made up of the housing section 61 and the gas charging section 62. The lid 64 hermetically seals the gas charging section 62 and is removably mounted on the main body unit 63. The opening member 65 thrusts the ejection button 51 of the gas ejection device 1 housed in the housing section 61 to open the carbonic gas cartridge container 5.

The housing section 61 is a cylindrically-shaped hollow recessed part in which can be housed the gas ejection device 1. The housing section 61 includes, as an opening end 61 a, an opened longitudinal end via which the gas ejection device 1 is introduced and removed. This opening end 61 a connects to one end 66a of an engagement groove 66 engaged by the conduit 47 protruded outwards from the housing 10 of the gas ejection device 1. Like the housing section 61, the engagement groove 66 faces outwards from a bottom 62a of the gas charging section 62 and, since the gas ejection device 1 is housed within the housing section 61, the engagement groove 66 is engaged by the conduit 47 to determine the housing position of the gas ejection device 1. The engagement groove 66 has an opposite end 66b facing the inside of a circular-shaped recess 67, formed in the bottom 62a of the gas charging section 62, via its sidewall section 67a. When the carbonic gas is charged into the gas charging section 62, the carbonic gas is introduced via the engagement groove 66 and the circular-shaped recess 67 into the conduit 47.

When the gas ejection device 1, not filled with the carbonic gas, is housed within the housing section 61, the gas charging section 62, filled with the carbonic gas, charges the liquefied carbonic gas via the conduit 47 into the carbonic gas cartridge container 5. The gas charging section 62 is in the form of a hollow cylinder and has the bottom 62a faced by the opening end 61 a of the housing section 61. A plural number of the arcuate-shaped housing sections 61 are formed in the bottom 62a. A circular-shaped recessed part 67 is formed at a mid part of the bottom 62a and encircled by the housing sections 61. The opposite end 66b of the engagement groove 66, engaged by the conduit 47 of the gas ejection device 1, faces a sidewall section 67a of the circular-shaped recess 67. When the inside of the gas charging section 62 is filled with the liquefied carbonic gas, the liquefied gas is introduced via this circular-shaped recess 67 into the engagement groove 66 and charged via the conduit 47 into the carbonic gas cartridge container 5 within the gas ejection device 1.

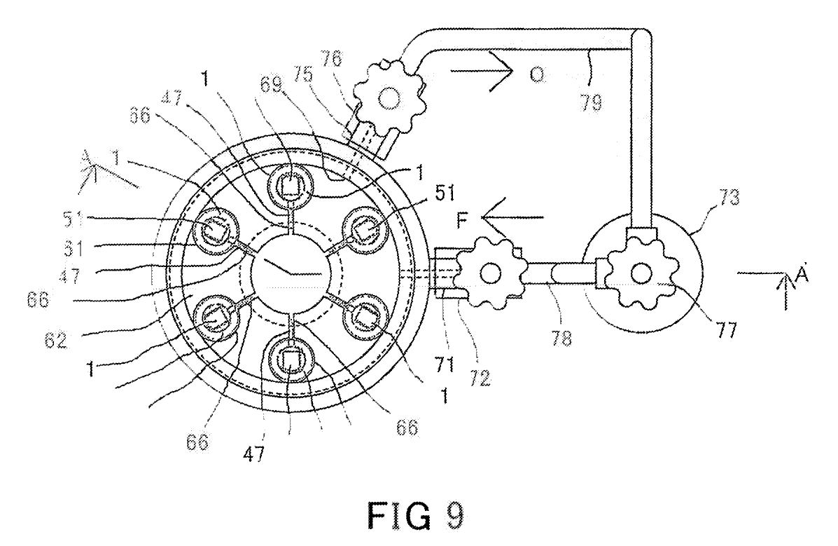

A gas inlet port 68, as a gas supply path via which to supply the liquefied carbonic gas, and a gas recovery port 69, for discharging the liquefied carbonic gas or recovering the liquefied carbonic gas, once introduced into the gas charging section 62, from the gas charging section 62, are provided in the gas charging section 62. The gas inlet port 68 connects to a hollow part 71 a of a first sleeve 71 protruded from the outer periphery of the main body unit 63. Referring to FIG. 9, a first gas duct 78 of a gas container 73, filled with the liquefied carbonic gas, connects to the gas inlet port 68 via a first valve 72, so that the liquefied carbonic gas can be introduced into the gas charging section 62 from the gas charging port 68. The gas recovery port 69 connects to a hollow part 75a of a second sleeve 75 protruded from the outer periphery of the main body unit 63. A second gas duct 79 of the gas container 73 connects to the second sleeve 75 via a second valve 76, so that the liquefied carbonic gas in the gas charging section 62 can be recovered to the gas container 73. The recovered liquefied carbonic gas is again introduced via the first valve 72 and the first sleeve 71 into the gas charging section 62.

The gas container 73, supplying the liquefied carbonic gas, includes a main valve 77, to which are connected a first gas duct 78 for supplying the carbonic gas to the first valve 72 and a second gas duct 79 for returning the carbonic gas from the second valve 76 to the main valve 77. When the gas ejection device 1 is housed in position in the housing section 61 and the gas charging section 62 is hermetically sealed by the lid 64, the main valve 77 and the first valve 72 are opened to permit the liquefied carbonic gas to flow in the direction of arrow F in FIG. 9 to introduce the liquefied carbonic gas via the gas inlet port 68. When the liquefied carbonic gas has been charged into the carbonic gas cartridge container 5, the first valve 72 is closed, while the second valve 76 is opened, whereby the liquefied carbonic gas flows in a direction indicated by arrow O in FIG. 9, so that the liquefied carbonic gas left in the gas charging section 62 is discharged via the gas recovery port 69. The liquefied carbonic gas, discharged from the gas charging section 62, is again recovered into the gas container 73 for use in the downstream side liquefied carbonic gas charging process. The main valve 77 and the second valve 76 are then closed, while the lid 64 is opened and the gas ejection device 1 is taken out of the housing section 61.

The outer periphery of the main body unit 63 is formed with a flange part 80 for mounting the lid 64 which hermetically seals the gas charging section 62. The flange part 80 is formed along the entire outer peripheral wall section of the main body unit 63. On this flange part is mounted the lid 64 which will be explained subsequently.

The lid 64 includes a sidewall section 85, engaged with the flange part 80 of the main body unit 63, and a major surface section 86. This major surface section 86 is mounted to a driving shaft 83 of a thrusting device that thrusts the lid 64. In the major surface section 86 is formed an arcuate insertion opening 87 via which is introduced an opening member 65 which is admitted into the gas charging section 62 to open the carbonic gas cartridge container 5 of the gas ejection device 1. A plural number of the arcuate insertion openings 87 are bored through the major surface section 86 as are the housing sections 61. The insertion openings 87 are formed in register with the ejection buttons 51 of the gas ejection devices 1 housed within the housing sections 61. Each insertion opening 87 is made up of a rectangular-shaped opening part 87a for retaining first and second retainers 95, 96 passed therethrough and a circular-shaped opening part 87b at a mid part along the length of the rectangular-shaped opening part 87a. The circular-shaped opening part is passed through by a shank part 91 of the opening member 65.

When the gas ejection device 1 is housed in the housing section 61, the lid 64 is mounted via a gasket 81 on an upper edge part of the main body unit 63 of the gas charging device 60. The lid 64 is thrust by the driving shaft 83 of the thrusting device to hermetically seal the gas charging section 62. At this time, the ejection button 51 of the gas ejection device 1 is placed facing the shank part 91 of the opening member 65. That is, the gas ejection device 1 is housed in position within the housing section 61 by having the conduit 47 engaged in the engagement groove 66 formed in the bottom 62a of the gas charging section 62. When the lid 64 is mounted in position, the insertion opening 87 is placed directly above the ejection button 51 provided on the cap 50. Thus, the opening member 65, introduced into the insertion opening 87, acts on the ejection button 51 of the gas ejection device 1 housed in the housing section 61 to open the carbonic gas cartridge container 5.

This opening member 65 includes the shank part 91 for pressing the ejection button 51 of the gas ejection device 1 and an operating part 92 provided on one end of the shank part 91 for rotating the opening member 65. The shank part 91 is formed with a first through-hole 93 and a second through-hole 94 at different height positions for extending in a direction perpendicular to the longitudinal direction. These through-holes are formed so that the longitudinal directions thereof are at right angles to each other. The through-holes are passed through by the first retainer 95 and the second retainer 96 that hold the opening member 65 at preset heights. The first and second retainers 95, 96 are set to be parallel to the rectangular-shaped opening part 87a of the insertion opening 87 of the lid 64 so that these retainers are introduced via the opening 87 into the gas charging section 62. Also, the retainers are set to be perpendicular to the rectangular-shaped opening part 87b and hence may be retained on the back side of the lid 64 to hold the opening member 65 at the preset height.

The operating part 92 that causes rotation of the opening member 65 includes a disc part 92a and a knob 92b formed on the upper surface of the disc part 92a. A stopper 99 for retaining a coil spring 98 biasing the opening member 65 upwardly of the lid 64 is introduced into a space between the disc part 92a and the first retainer 95. The stopper 99 is substantially disc-shaped and includes a center opening passed through by the shank part 91. The stopper 99 is passed through by the shank part 91 and abutted by one end of the coil spring 98. The other end of the coil spring 98 is abutted by the disc part 92a of the operating part 92. When the shank part 91 of the opening member 65 is inserted into the insertion opening 87, the stopper 99 abuts against the major surface section 86 of the lid 64. When the shank part 91 is intruded further, the shank part 91 is biased upwards at all times by the coil spring 98 abutted against the operating part 92.

When the first retainer 95 is introduced from the insertion opening 87, and the knob 92b of the operating part 92 is rotated, the opening member 65 is retained by the back side of the lid 64. The shank part 91 presses the ejection button 51 of the gas ejection device 1 to hold it at a position of opening the carbonic gas cartridge container 5. The second retainer 96 is introduced via the insertion opening 87 and the knob 92b of the operating part 92 is rotated for retaining the opening member 65 on the back side of the lid 64. The shank part 91 of the opening member 65 is then spaced apart from the ejection button 51 of the gas ejection device 1 to hold the carbonic gas cartridge container 5 in the closed state.

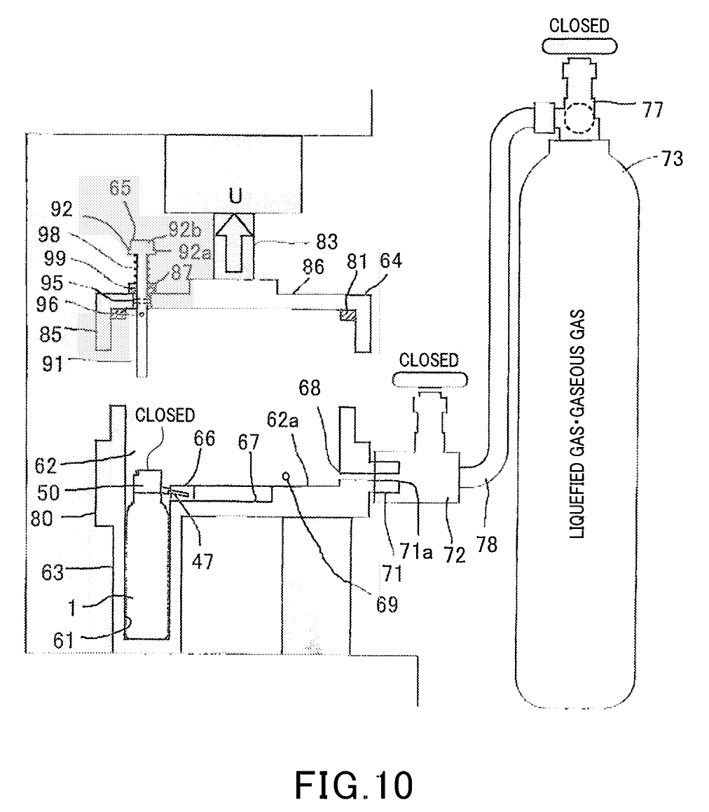

The process of charging the carbonic gas into the carbonic gas cartridge container 5, using the gas charging device 60 according to the present invention, is now described with reference to FIGS. 9 to 12. It is noted that FIGS. 10 to 12 are cross-sectional views taken along line A-A of FIG. 9.

Initially, the gas ejection device 1 is introduced into the gas charging device 60. At this time, the first gas duct 78 and the second gas duct 79 are connected to the first sleeve 71 and the second sleeve 75 of the main body unit 63 of the gas charging device 60, as shown in FIG. 9. Hence, the gas charging device 60 is connected to the gas container 73 as a supply source of the carbonic gas. The first valve 72 interposed between the first sleeve 71 and the first gas duct 78, the second valve 76 interposed between the second sleeve 75 and second gas duct 79 and the main valve 77 of the gas container 73 are all closed. The opening member 65 is retained at a position in which the shank part 91 has been introduced into the insertion opening 87, and the second retainer 96 has been retained by the back side of the lid 64. At this position, the ejection button 51 of the gas ejection device 1 and the shank part 91 are separated from each other during closure of the lid 64.

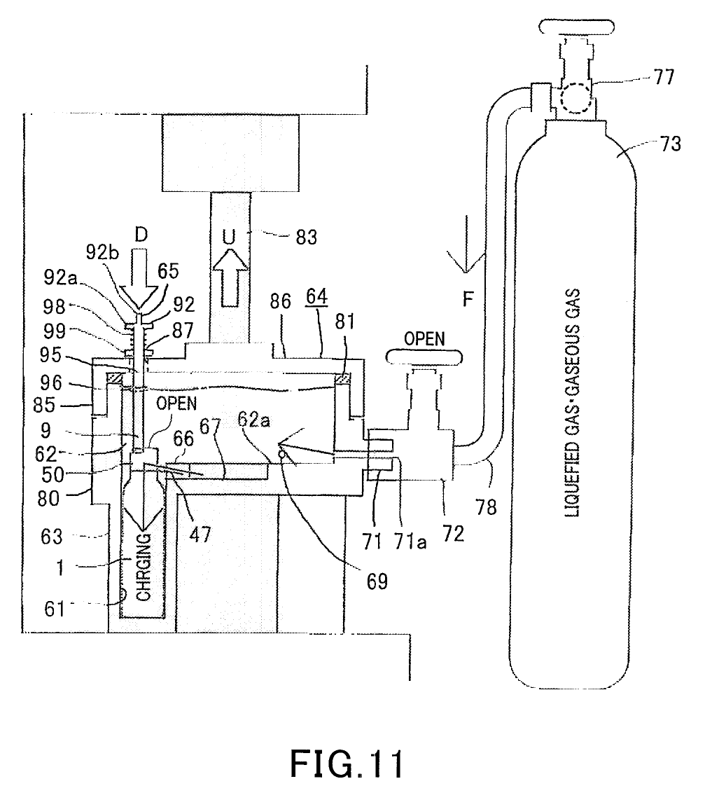

Referring to FIG. 10, when the lid 64 has been uplifted by the driving shaft 83 away from the main body unit 63, in a direction of arrow U in FIG. 10, the gas ejection device 1 is housed in the housing section 61 that faces outwards via the bottom 62a of the gas charging section 62. The gas ejection device 1 is housed at this time in an orientation in which the conduit 47 is engaged with the engagement groove 66 connecting to the upper end of the housing section 61. Thus, the gas ejection device 1 is housed in position with the ejection button 51 facing the shank part 91 of the opening member 65 traversing the lid 64 of the gas charging device 60. When a preset plural number of the gas ejection devices 1 have been housed in all of the housing sections 61, the lid 64 is moved by the driving shaft 83 in a direction opposite to the arrow U in FIG. 11, Thus, the gas ejection devices 1 are mounted in position on the main body unit 63 to hermetically seal the gas charging sections 62.

The knob 92b of the operating part 92 of the opening member 65 is then rotated, as shown in FIG. 11, to thrust it into the lid 64 in a direction of arrow D in FIG. 11 to push down the ejection button 51 of the gas ejection device 1. With the ejection button 51 thus pushed down, the knob 92b is rotated to retain the first retainer 95 by the back side of the lid 64. This holds the opening member 65 against the bias of the coil spring 98. By holding the opening member 65 under the pressed state of the ejection button 51, the thrusting shank 21 of the operating member 9 of the gas ejection device 1 is moved downwards. The end 20a of the lever member 20, engaging with the thrusting shank 21, is rotated downwards, about the rotational lugs 24 as fulcrum, while its other end 20b is rotated upwards. Hence, the side edge parts 22a, 22a formed at the other end 20b of the lever member 20 are abutted by the protuberance 30 of the flange part 17. Thus, the holder 7 is uplifted, against the bias of the torsion coil spring 8, and separated from the sealing plate 14 of the carbonic gas cartridge container 5. This uplifts the needle end part 6a of the needle-like member 6, carried by the holder 7, away from the pierced opening 14a of the sealing plate 14 of the carbonic gas cartridge container 5. Hence, the carbonic gas cartridge container 5 is kept in its opened state.

The main valve 77 and the first valve 72 of the gas container 73 are then opened. This causes the liquefied carbonic gas, charged in the gas container 73, to flow in a direction of arrow F in FIG. 9 via first gas duct 78 and the hollow part 71a of the first sleeve 71 into the gas charging section 62 via the gas inlet port 68. The liquefied carbonic gas, charged into the gas charging section 62, flows into the circular-shaped recess 67 of the gas charging section 62 and into the housing section 61. In addition, the liquefied carbonic gas flows into the gas duct 11 in the gas ejection device 1, housed within the housing section 61, so as to be charged via the pierced opening 14a of the sealing plate 14 into the carbonic gas cartridge container 5.

With the gas charging device 60 of the present invention, the gas ejection device 1 is immersed in the liquefied carbonic gas, and hence the gas ejection device 1 in its entirety is in a pressurized state. If the gas duct is directly connected to the conduit 47 and the liquefied carbonic gas is injected under a high pressure, the high pressure is applied to a localized site, thus giving rise to the risk of possible explosion of the conduit 47. On the contrary, with the present charging process, it is possible to repeatedly charge the carbonic gas without the risk of destruction of the gas ejection device 1.

The charging of carbonic gas and the sealing of the sealing plate 14 may be achieved by a simplified process comprised of opening/closing the carbonic gas cartridge container 5 by pushing down the ejection button 51 by the opening member 65 and immersing the gas ejection device 1 in the liquefied carbonic gas. It is sufficient to re-introduce the needle-like member 6, pricked into the sealing plate, into the sealing plate by pressing down the ejection button 51, or withdraw it therefrom to enable opening/closure of the carbonic gas cartridge container 5. Hence, the gas may readily be filled without the necessity of carrying out a complex process of welding the sealing pate in a gas-tight state of the charged gas. Moreover, the gas charging device is not complicated in structure or bulky in size because there is no necessity of providing a hermetically sealed chamber fitted with a welding mechanism. Hence, the gas ejection device 1 does not have to be made disposable and may prove a product amenable to environment. Additionally, with the present charging process, the housing 10 may be cleaned because the gas ejection device 1 is immersed in the liquefied carbonic gas.

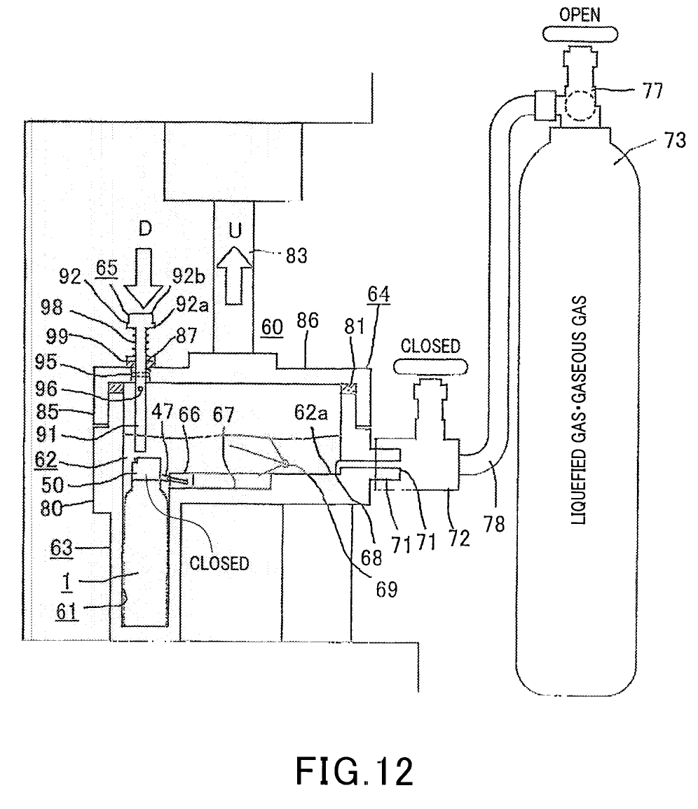

After immersing the gas ejection device 1 in the carbonic gas, charged in the gas charging section 62, for a preset time, the opening member 65 is rotated to raise the shank part 91 in a direction opposite to the arrow D to have the second retainer 96 retained by the back side of the lid 64 to hold the opening member 65, as shown in FIG. 12. This separates the shank part 91 from the ejection button 51 of the gas ejection device 1 to release the pressure so far applied to the thrusting shank 21. Hence, the holder 7 is biased towards the carbonic gas cartridge container 5, under the force of the torsion coil spring 8, and the needle-like member 6, carried by the holder 7, is pricked into the pierced opening 14a of the sealing plate 14 of the carbonic gas cartridge container 5. This closes the carbonic gas cartridge container 5.

The first valve 72 is then closed to halt the liquefied carbonic gas from flowing via the gas inlet port 68. The second valve 76 is then opened to discharge the liquefied carbonic gas, left in the gas charging section 62, via the gas recovery port 69. The liquefied carbonic gas, discharged from the gas recovery port 69, flows through the second gas duct 79 in a direction of arrow O in FIG. 9 in readiness for being re-charged via first gas duct 78 into the gas charging section 62.

When the liquefied carbonic gas, left in the gas charging section 62, is discharged from the gas recovery port 69, the second valve 76 and the main valve 77 are closed. The lid 64 is uplifted by the driving shaft 83 of the thrusting device in a direction of arrow U in FIG. 10 to permit the gas ejection device 1, filled with the carbonic gas, to be taken out. In this manner, the process of charging the carbonic gas into the carbonic gas cartridge container 5 comes to a close. The gas ejection device 1, not filled with the carbonic gas, is again housed in the housing section 61, and the main valve 77 as well as the first valve 72 is opened to repeat the carbonic gas charging process.

Meanwhile, in the gas charging device 60 of the present invention, the gas charging section 62 may be evacuated by a vacuum pump, via an evacuation port, provided at a lower extreme end of the housing section 61 or the gas charging section 62, after placing the gas ejection device 1 within the housing section 61, hermetically sealing the gas charging section 62 with the lid 64 and opening the carbonic gas cartridge container 5 by the opening member 65, and before charging the liquefied carbonic gas into the gas charging section 62. By setting up the vacuum state in the gas charging section 62 in advance, the liquefied carbonic gas, charged into the gas charging section 62, may reliably be introduced into the carbonic gas cartridge container 5 based on the pressure differential between the gas container 73 and the gas charging section 62.

Although the liquefied carbonic gas is used as the gas charged into the gas ejection device 1, the present invention may be applied to a variety of gases other than the liquefied carbonic gas, such as gaseous carbonic gas or a nitrogen gas in the liquid or gaseous state. The gas charged may also be an admixture of the gas with hair dressing liquid, paint or a liquid flavor enhancer

1. A gas charging device comprising:
a housing section for housing a gas ejection device;
said gas ejection device including
a gas container and an operating member for opening/closing said gas container;
a gas charging section formed with a supply duct for a gas and faced by an end of said housing section;
a lid for hermetically sealing said gas charging section; and
an opening member engaged with said operating member for opening said gas container; wherein
said gas charging section, having said gas ejection device housed in said housing section, is hermetically sealed by said lid; said gas container of said gas ejection device is opened by said opening member; said gas is introduced via said supply duct into said gas charging section to immerse said gas ejection device in said gas to charge said gas into said gas container.

2. The gas charging device according to claim 1 wherein said gas ejection device includes said gas container, having an opening part sealed by a sealing plate and filled with said gas in a compressed state; a needle-like member pricked into a pierced opening formed in said sealing plate to close said sealing plate; a holder for holding said needle-like member at one end thereof so that said needle-like member faces said sealing plate; said holder being movable into contact with or away from said sealing plate; a biasing member for biasing said holder towards said sealing plate; said operating member having an operating lever and a thrusting member; and a housing for housing said gas container and said holder and having a gas duct for outwardly guiding said compressed gas ejected out of said pierced opening formed in said sealing plate; said operating lever being abutted by said holder at one side thereof referenced to a fulcrum provided at a portion along the length of the operating lever, to cause movement of said holder in a direction away from said sealing plate to open said gas container; said thrusting member engaging with and thrust by an opposite side end of said operating lever referenced to said fulcrum to cause rotation of the operating lever in a direction of moving the holder away from the sealing plate to uplift said needle-like member out of said pierced opening to open said gas container;
said opening member thrusting said operating member to open said gas container.

3. The gas charging device according to claim 1 wherein a conduit provided with said gas duct is protruded from said gas ejection device;
said housing section includes an engagement groove engaged by said conduit for guiding a housing position of said gas ejection device; and wherein
said opening member is provided facing said operating member of said gas ejection device guided and housed in said housing position in said housing section.

4. The gas charging device according to claim 1 wherein a plurality of said housing sections are formed in said gas charging section.

5. The gas charging device according to claim 1 wherein said gas charging section includes evacuation means.

6. A method for producing a gas ejection device comprising
housing a gas ejection device in a housing section facing a gas charging section provided with a duct for supplying a gas;
closing a lid for hermetically sealing said gas charging section;
engaging an operating member, configured to open or close a gas container housed in said gas ejection device, by an opening member, for opening said gas container;
introducing said gas via said duct into said gas charging section for immersing said gas ejection device in said gas for charging said gas in said gas container; and
disengaging said opening member from said operating member after halting the supply of said gas to close said gas container to take out said gas ejection device from said housing section.

7. The method for producing a gas ejection device according to claim 6 wherein said gas ejection device includes said gas container, having an opening part sealed by a sealing plate and filled with said gas in a compressed state; a needle-like member pricked into a pierced opening formed in said sealing plate to close said sealing plate; a holder for holding said needle-like member at one end thereof so that said needle-like member faces said sealing plate; said holder being movable into contact with or away from said sealing plate; a biasing member for biasing said holder towards said sealing plate; said operating member having an operating lever and a thrusting member; and a housing for housing said gas container and said holder and having a gas duct for outwardly guiding said compressed gas ejected out of said pierced opening formed in said sealing plate; said operating lever being abutted by said holder at one side thereof referenced to a fulcrum provided at a portion along the length of the operating lever to cause movement of said holder in a direction away from said sealing plate to open said gas container; said thrusting member engaging with and thrust by an opposite side end of said operating lever referenced to said fulcrum to cause rotation of the operating lever in a direction of moving the holder away from the sealing plate to uplift said needle-like member out of said pierced opening to open said gas container; and wherein
said opening member thrusts said operating member to open said gas container.

8. The method for producing a gas ejection device according to claim 6 wherein a conduit provided with said gas duct is protruded from said gas ejection device; an engagement groove engaged by said conduit is provided in said housing section; and wherein said gas ejection device is housed in said housing section as the housing position of said gas ejection device is determined by a nozzle guided by said engagement groove;
said opening member being provided facing said operating member of said gas ejection device guided and housed in said housing position in said housing section,

9. The method for producing a gas ejection device according to claim 6 wherein a plurality of said housing sections are provided in said gas charging section and wherein the gas is introduced via said supply duct into each of a plurality of said gas ejection devices.

10. The method for producing a gas ejection device according to claim 6 wherein said gas charging section is provided with evacuation means and wherein said gas charging section is evacuated after hermetically sealing said gas charging section.

11. A gas charging method comprising:
housing a gas ejection device in a housing section facing a gas charging section including a supply duct for supplying a gas; said gas ejection device including a container having an opening part sealed by a sealing plate and filled with a compressed gas; a needle-like member pricked into a pierced opening formed in said sealing plate to close said sealing plate; a holder carrying said needle-like member at one end thereof facing a sealing plate of said container; said holder being movable into contact with and away from said sealing plate; a biasing member for biasing said holder towards said sealing plate of said container; an operating member for operating said holder in a direction away from said holder for extracting said needle-like member out of said pierced opening to open said container; and a housing for housing said container and said holder and including a gas duct for outwardly guiding the compressed gas ejected via said pierced opening in said sealing plate;
hermetically sealing said gas charging section;
pressing down said operating member by an opening member to open said gas container; and
introducing the gas from said supply duct into said gas charging section via said supply duct for immersing said gas ejection device in said gas for charging the gas in said gas container.
